(19) United States
(12) Patent Application Publication
(10) Pub. No.: US 2026/0176860 A1
(43) Pub. Date: Jun. 25, 2026

(54) LEAK CONTROL FLANGE

(71) Applicants: Troy Creighton, New South Wales (AU); Peter Tucker, New South Wales (AU)

(72) Inventors: Troy Creighton, New South Wales (AU); Peter Tucker, New South Wales (AU)

(21) Appl. No.: 19/425,130

(22) Filed: Dec. 18, 2025

(30) Foreign Application Priority Data
Dec. 20, 2024 (AU) 202490462

(51) Int. Cl. E03F 5/04

(52) U.S. Cl. CPC E03F 5/0409

(57) ABSTRACT

The present invention may lie in a leak control flange that comprises a hollow, cylindrical riser portion forming a throat therethrough; a horizontal flange portion extending outwardly from an upper end of the riser portion; horizontal channels that each extend, from a channel inlet on a periphery of the flange portion, along an underside of the flange portion, and inwardly towards the riser portion. The cylindrical riser portion includes a plurality of sealing rings arranged axially therealong, each sealing ring being configured to engage an outer surface of the riser portion to form a sealing interface therewith. Each sealing ring includes one or more capillary passages therein, which are configured to permit liquid to flow downwardly under gravity past the sealing ring while resisting upward flow of liquid.

### CROSS-REFERENCE TO RELATED APPLICATIONS

The present application claims priority to and the benefit of Australian Patent Application No. 2024904262, filed Dec. 20, 2024, the contents of which are incorporated herein by reference and made a part hereof.

### TECHNICAL FIELD

The present invention relates generally to the field of plumbing installations.

### BACKGROUND

Leak control flanges are an essential element of plumbing in certain types of ‘wet rooms’ such as shower cubicles, and act as a junction between a drainage pipe and the floor or floor substrate. In use, a leak control flange is fitted into the open end of a pipe and provides a flat surface for waterproof sheet to be laid down and adhered across the floor or substrate and extend right up to the drain pipe opening. A leak control flange may be referred to as a ‘leak bypass joint end’ or ‘floor flange’. A leak control flange may also occasionally (and incorrectly) be referred to as a ‘puddle flange’, however a puddle flange is actually a type of flange that is intended to be embedded within a concrete structure with no part of the flange left exposed. Although wet rooms such as shower cubicles are waterproofed, imperfect installations may enable water to work its way under the waterproof sheet and become trapped. This may also occur with general wear and tear that occurs with time, as well as stresses from movement of the building due to, e.g., earth movement, the building settling, nearby construction, storms and other natural events, etc.

Leak control flanges also require that the flange have a minimum flange diameter (being the length from the edge of the throat to the outer edge of the flange) in order to ensure that the flange has sufficient surface area for proper adhesion between the flange and the waterproofing sheet. Minimum flange diameter may be mandated by applicable plumbing installation standards. Additionally, there generally needs to be sufficient space between the outer edge of the flange and the bond breaker and spacer fillet, so that the waterproofing sheet can maximise adhesion to the floor substrate and wall sheet on either side of said bond breaker and spacer fillet to counteract any uplift or freeing of the waterproofing sheet caused by it not adhering across the bond breaker.

It would be advantageous to provide a leak control flange that is able to ameliorate one or more of the above problems and/or limitations. These may be provided by one or more embodiments of the invention disclosed herewithin.

### DISCLOSURE OF THE INVENTION

In a first embodiment, the present invention may reside in a leak control flange, comprising a hollow, cylindrical riser portion forming a throat therethrough; a horizontal flange portion extending outwardly from an upper end of the riser portion; horizontal channels that each extend, from a channel inlet on a periphery of the flange portion, along an underside of the flange portion, and inwardly towards the riser portion; wherein the cylindrical riser portion includes a plurality of sealing rings arranged axially therealong, each sealing ring being configured to engage an outer surface of the riser portion to form a sealing interface therewith; and each sealing ring includes one or more capillary passages therein, which are configured to permit liquid to flow downwardly under gravity past the sealing ring while resisting upward flow of liquid.

Preferably, the plurality of sealing rings comprises at least three adjacent sealing rings.

Preferably, the capillary passages of adjacent sealing rings are angularly offset relative to one another about a circumference of the riser portion.

Preferably, the sealing rings collectively define a tortuous or labyrinth flow path for liquid moving along the riser portion.

Preferably, the sealing rings, flange portion and the riser portion are formed from an elastomeric material, and the riser portion is adapted to be compression fit into engagement with a plumbing fixture..

Preferably, the sealing rings are integrally formed with the riser portion.

Preferably, the leak control flange further comprising a lip seal positioned below the plurality of sealing rings.

Preferably, the sealing rings and lip seal cooperate to permit gravity-driven drainage while inhibiting pressure-driven backflow.

Preferably, at least the flange portion is adapted to be able to flex upwards and/or downwards.

Preferably, the leak control flange further comprising, on an upper surface of the flange portion: a size ring, centred about the throat, denoting minimum flange diameter; and an indicator grid formed of evenly spaced intersecting lines at right angles, extending across the upper surface of the flange portion outside of the size ring.

Preferably, the leak control flange further comprising a capping structure protruding upwardly from the flange portion proximal to the throat and extending thereover in a sealing manner.

Preferably, the capping structure comprises an upwardly extending water level gauge.

Preferably, the water level gauge is an upwardly extending protrusion with a series of equally spaced markings along its length

Preferably, the water level gauge is at least partially formed by concentrically stacked cylinders of equal height and decreasing diameter.

Preferably, the leak control flange further comprising a guide lip extending peripherally around a base of the capping structure.

In accordance with another embodiment, the present invention may reside in a leak control flange, comprising: a hollow, cylindrical riser portion forming a throat therethrough; a horizontal flange portion extending outwardly from an upper end of the riser portion; horizontal channels that each extend, from a channel inlet on a periphery of the flange portion, along an underside of the flange portion, and inwardly towards the riser portion; and vertical channels that each extend substantially vertically along an outer surface of the riser portion to a channel outlet at a lower end thereof; wherein at least a first portion of the horizontal channels meet and open into an upper end of one of the vertical channels.

Preferably, the leak control flange further comprising a plurality of one-way valves arranged to inhibit liquid backflow in through the channel outlets and/or out through the channel inlets.

Preferably, the horizontal channels extend through a wall of the riser portion and open into the throat; and the leak control flange further comprises a plurality of one-way valves arranged to inhibit liquid backflow entering the horizontal channels from within the throat.

Preferably, the vertical channels are adapted to provide compression gaps for the riser portion to promote compression fitting.

Further or alternative embodiments of the invention may be disclosed herein or may otherwise become apparent to the person skilled in the art through the disclosure herein. These and other embodiments are considered to fall within the scope and object of the invention.

### DESCRIPTION OF FIGURES

Embodiments of the present invention will now be described in relation to figures, wherein:

FIG. 1 depicts a first preferred embodiment of a leak control flange of the present invention;

FIG. 2 shows an underside view of the embodiment of the leak control flange depicted in FIG. 1;

FIGS. 3 and 4 show the embodiment of the leak control flange depicted in FIG. 1 installed in an example wet room;

FIG. 5 shows a top plan view of the embodiment of the leak control flange depicted in FIG. 1 further comprising a capping structure;

FIG. 6 and Insets 1A & 1B depict a further embodiment of a leak control flange of the present invention comprising an alternate sealing arrangement; and

FIG. 7 shows another embodiment of a leak control flange of the present invention

### DETAILED DESCRIPTION OF PREFERRED EMBODIMENTS

In an embodiment, the present invention may reside in a leak control flange that is adapted to enable removal of water or other liquids that may circumvent an overlaid waterproofing layer.

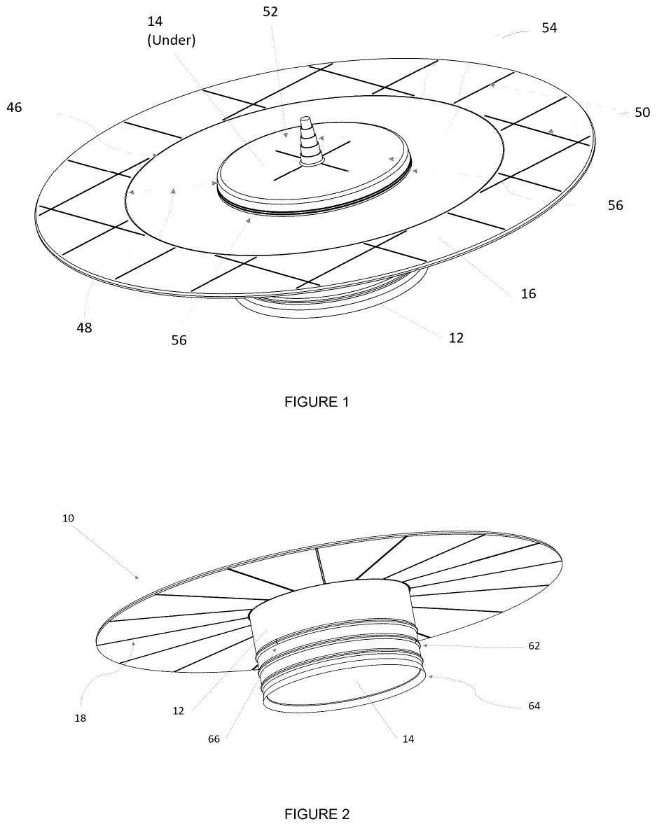

A first preferred embodiment of the present invention is shown in FIGS. 1 to 5. The leak control flange 10 may comprise a hollow, cylindrical riser portion 12 that engages with a plumbing fixture such as a pipe end (not depicted) and forming a throat 14 therethrough. The leak control flange 10 further comprises a horizontally extending flange portion 16 that extends outwardly from an upper end of the riser portion 12. In this preferred embodiment the leak control flange 10 may further comprise horizontal channels 18 that each extend, from a channel inlet 20 on a periphery of the flange portion 16, along an underside 22 of the flange portion, and inwardly towards the riser portion 12. Positioned on the riser portion 12 are a plurality of sealing rings 62 (preferably three sealing rings as shown, but certainly not limited to three sealing rings as depicted - any suitable number will fall within the scope of the invention) in combination with a lip seal 64. Each sealing ring 62 is configured to engage with the outer surface of the riser portion 12 that extends from the flange portion 16, thereby forming a labyrinth-type sealing interface between the riser portion and the pipe.

As is best shown in FIG. 2, each sealing ring 62 includes one or more capillary passages or slots 66 formed therein. The capillary passages 66 are configured to permit gravity-fed liquid to flow downwardly past the sealing ring 62 while resisting upward flow of the liquid back through the capillary passages. Preferably, the capillary passages 66 of adjacent sealing rings are offset relative to one another around the circumference of the riser portion, such that the capillary passages are not vertically aligned. This offset creates a tortuous flow path that further inhibits backflow while still allowing drainage under gravity. It is also particularly preferred that the capillary passages extend through each of the sealing rings at an angle rather than directly vertically.

The lip seal 64 is positioned below the sealing rings 62 and is configured to provide a directional sealing function, resisting upward liquid movement (i.e. in a direction opposite to the flow of liquid under the force of gravity) but permitting downward liquid flow along the pipe. The lip seal 64 may be formed from an elastomeric material and oriented such that fluid pressure from above increases sealing effectiveness.

This preferred embodiment provides improved sealing performance in environments subject to intermittent water exposure, surface pooling, or transient pressure differentials, while maintaining compatibility with existing installation practices. The sealing rings 62 and lip seal 64 may be integrally formed with the riser portion 12 (which is preferred), or they may be provided as separate components that are retained on the outer surface of the riser portion.

Returning to FIG. 1, the leak control flange 10 may comprise a size ring 46 that is located on an upper surface of the flange portion 16 and centred about the throat 14. The size ring 46 may denote minimum flange diameter 48. In a further embodiment, the leak control flange 10 may further comprise an indicator grid 50 that is formed of evenly spaced intersecting lines at right angles, extending across the upper surface of the flange portion 16 outside of the size ring 46. The indicator grid 50 may be shaped to provide cutting guides for shaping of the leak control flange 10 prior to installation. Whilst not shown in the drawings, a cutting jig can be used to best cut and shape the leak control flange 10 to the preferred size.

Best shown in FIGS. 1 and 5, the leak control flange 10 may further comprise a capping structure 52 that sealingly extends across or over the throat 14. As depicted in FIG. 1, the capping structure 52 may upwardly protrude from the flange portion 16 proximal to the throat 14 and extend thereover in a sealing manner. The capping structure, in sealing the throat 14 of the leak control flange 10, may inhibit construction materials or other debris entering the throat 14 and pipe 36 (not depicted in FIGS. 1 to 5) during the installation process. The capping structure may also enable a flood test to be conducted without needing the drain to be manually blocked or sealed. The capping structure 52 may be configured to be cut or trimmed away by the user so as to unseal the throat 14 once construction or installation is complete. It is preferred that the capping structure 52 has a larger diameter than the diameter of the throat 14. This way, when the capping structure 52 is cut away from the horizontally extending flange portion 16, the capping structure cannot fall into the throat 14 or fall through it into the drain pipe 36.

In a further embodiment, the capping structure 52 may comprise an upwardly extending water level gauge 54. The water level gauge 54 may enable a flood test to be conducted with greater ease and accuracy, as the gauge may enable changes in water depth be detected and measured in a standardised manner. In an example embodiment, the water level gauge may comprise an upward protrusion with a series of equally spaced markings along its length. In an alternate example embodiment, the water level gauge 54 may be at least partially formed by concentrically stacked cylinders of equal height and decreasing diameter.

In an embodiment, the capping structure 52 may comprise a guide lip 56 at a base thereof. The guide lip may serve to provide a guide for the installation of a layer such as a waterproof sheet 44 that extends onto the flange portion 16 of the leak control flange 10, and may further serve to indicate a required minimum thickness of such a layer. This may be particularly advantageous when the layer is formed of, e.g., a plurality of sheets of a thin membrane that must be layered to achieve the requisite thickness, or a liquid or gel that must be laid down and permitted to set so as to form into the layer. In a further embodiment (not depicted) the guide lip 56 may be formed of multiple steps.

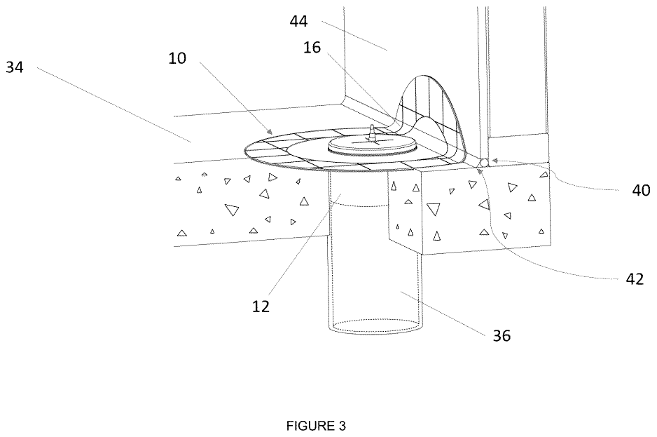

Turning now to FIG. 3, depicted is section view of a shower cubicle, wherein an embodiment of the leak control flange 10 of the present invention installed into a recess cut into a floor substrate 34, with the flange portion 16 of the leak control flange 10 sitting within the recess and the riser portion 12 (depicted with dotted lines) being fitted into an end of a drain pipe 36. Also depicted are the inward-facing wall sheet 44 that is typically fixed to the shower cubicle frame (e.g. a wall stud), the sealant 40 between the wall sheet and the floor substrate 34, and bond breaker with spacer fillet 42. Not depicted is the waterproof sheet that would be subsequently laid over the leak control flange 10 and floor substrate 34, and extend up the wall sheet 44. In an embodiment and as depicted in FIG. 3, at least the flange portion 16 may be adapted to be able to flex upwards and/or downwards, thereby enabling the leak control flange to be adapted to conform to a shape of the surface area surrounding the drain pipe 36.

Without limiting the scope of the invention through theory, as depicted in FIG. 3 it is envisaged that one example use of at least the present embodiment may enable a drain pipe 36, and in particular its open end, to be positioned closer to the wall sheet 44 than a minimum flange diameter without overly inhibiting the functionality of said leak control flange 10 or inhibiting the ability of the waterproof sheet to be properly installed. In particular, by flexing the flange portion 16 of the leak control flange 10 to conform to the wall sheet 44, the diameter of the flange portion 16 can be maintained to ensure that there is sufficient flange surface area for the waterproof sheet to adhere thereto, even if the length of floor substrate between the open end of the drain pipe 36 and the wall sheet 44 is less than the minimum flange diameter. In an embodiment, at least the flange portion may be formed from an elastomeric material. The elastomeric material may be plasticised polyvinyl chloride (PVC) (which is preferred), or any other suitable material including rubber, polyurethane, silicone rubber, or any other flexible material known in the art as being suitable for constructing plumbing elements.

In an embodiment wherein vertical channels 24 are present, the vertical channels 24 may be adapted to provide compression gaps for the riser portion 12 to promote compression fitting thereof.

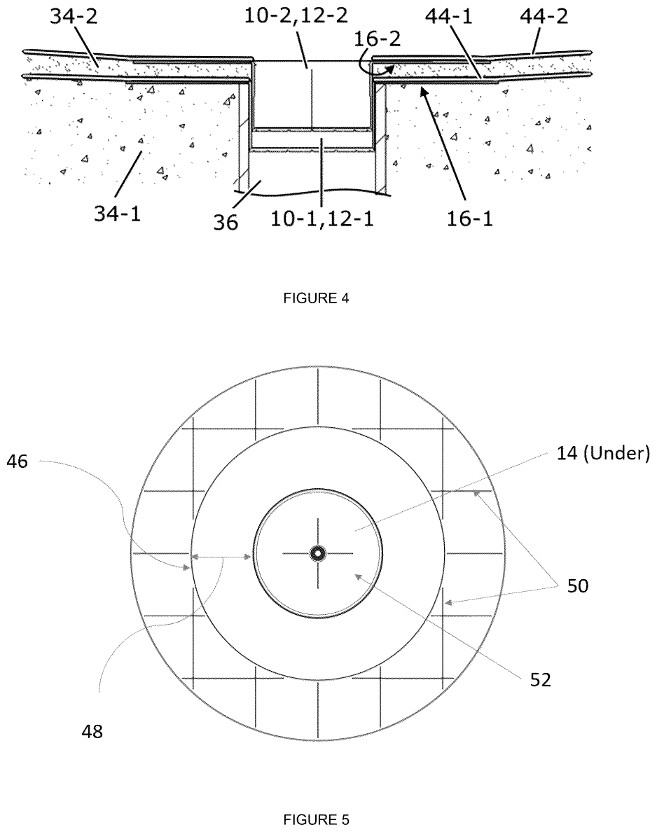

In some embodiments, the riser portion 12 being adapted for compression fitting may also enable waterproof sheet and floor substrate stacking. With reference to FIG. 4, depicted is a first floor substrate 34-1, with the riser portion 12-1 of a first leak control flange 10-1 compression fit into an open end of a pipe 36, and a first waterproof sheet 44-1 laid thereover and adhered thereto. The riser portion 12-2 of a second leak control flange 10-2 may be compression fit into the first leak control flange 10-1, sandwiching the first waterproof sheet 44-1 between the respective flange portions 16-1, 16-2, with a second waterproof sheet 44-2 laid thereover and adhered thereto. As depicted in FIG. 4, a second floor substrate 34-2 may also be present, overlaying the first waterproof sheet 44-1 and having a recess for the flange portion 16-2 of the second leak control flange 10-2 to sit within.

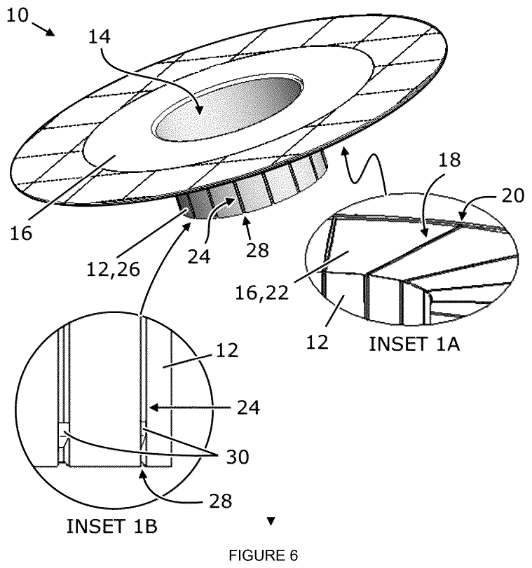

In another embodiment of the leak control flange 10 of the present invention and with reference to FIG. 6 and Insets 1A & 1B, the leak control flange 10 may comprise either horizontal channels 18 that each extend, from a channel inlet 20 on a periphery of the flange portion 16, along an underside 22 of the flange portion, and inwardly towards the riser portion 12, or vertical channels 24 that each extend substantially vertically along an outer surface 26 of the riser portion 12 to a channel outlet 28 at a lower end thereof. In a further embodiment and as particularly depicted in Inset 1A, the leak control flange 10 may comprise both horizontal and vertical channels 18, 24.

With further reference to Inset 1A, in a further embodiment comprising both horizontal and vertical channels 18, 24, at least a first portion of the horizontal channels 18 may meet and open into an upper end of a corresponding one of the vertical channels 24. In a further embodiment (not shown) a further portion of the horizontal channels 18 may be tributary channels that meet and feed into one of the horizontal channels of the first portion.

In an embodiment and with further reference to Inset 1B, the leak control flange 10 may further comprise a plurality of one-way valves 30 that are arranged to inhibit liquid backflow in through the channel outlets 28 (as depicted) and/or out through the channel inlets 20. As the skilled person will appreciate, the one-way valve 30 depicted in Inset 1B is one example of a suitable one-way valve or check valve. Other suitable one-way valves may be used without departing from the scope or object of the invention, such as gate-type valves, nozzle-type valves or flap-type valves.

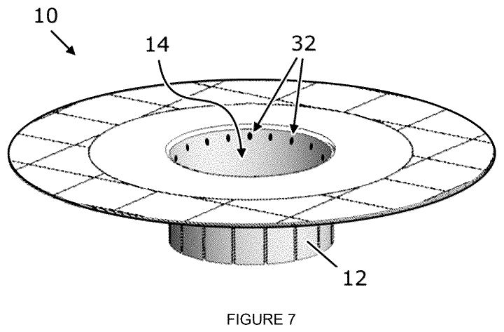

In an embodiment and with reference to FIG. 7, the horizontal channels 18 may extend through a wall of the riser portion 12 and open into the throat 14 through openings 32. In a further embodiment, the leak control flange 10 may further comprise a plurality of one-way valves (not depicted) that are arranged to inhibit liquid backflow from entering the horizontal channels 18 from within the throat 14.

It will be appreciated that the number, geometry, and arrangement of sealing rings, capillary passages, and lip seals may be varied without departing from the scope of the invention.

While the invention has been described with reference to preferred embodiments above, it will be appreciated by those skilled in the art that it is not limited to those embodiments, but may be embodied in many other forms, variations and modifications other than those specifically described. The invention includes all such variation and modifications. The invention also includes all of the steps, features, components and/or devices referred to or indicated in the specification, individually or collectively and any and all combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Any promises made in the present document should be understood to relate to some embodiments of the invention, and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

1. A leak control flange, comprising:
a hollow, cylindrical riser portion forming a throat therethrough;
a horizontal flange portion extending outwardly from an upper end of the riser portion;
horizontal channels that each extend, from a channel inlet on a periphery of the flange portion, along an underside of the flange portion, and inwardly towards the riser portion;
wherein the cylindrical riser portion includes a plurality of sealing rings arranged axially therealong, each sealing ring being configured to engage an outer surface of the riser portion to form a sealing interface therewith; and
each sealing ring includes one or more capillary passages therein, which are configured to permit liquid to flow downwardly under gravity past the sealing ring while resisting upward flow of liquid.

2. The leak control flange according to claim 1, wherein the plurality of sealing rings comprises at least three adjacent sealing rings.

3. The leak control flange according to claim 1, wherein the capillary passages of adjacent sealing rings are angularly offset relative to one another about a circumference of the riser portion.

4. The leak control flange according to claim 3, wherein the sealing rings collectively define a tortuous or labyrinth flow path for liquid moving along the riser portion.

5. The leak control flange according to claim 1, wherein the sealing rings, flange portion and riser portion are formed from an elastomeric material, and the riser portion is adapted to be compression fit into engagement with a plumbing fixture.

6. The leak control flange according to claim 1, wherein the sealing rings are integrally formed with the riser portion.

7. The leak control flange according to claim 1 further comprising a lip seal positioned below the plurality of sealing rings.

8. The leak control flange according to claim 7, wherein the sealing rings and lip seal cooperate to permit gravity-driven drainage while inhibiting pressure-driven backflow.

9. The leak control flange of claim 1, wherein at least the flange portion is adapted to be able to flex upwards and/or downwards.

10. The leak control flange of claim 1 further comprising, on an upper surface of the flange portion:
a size ring, centred about the throat, denoting minimum flange diameter; and
an indicator grid formed of evenly spaced intersecting lines at right angles, extending across the upper surface of the flange portion outside of the size ring.

11. The leak control flange of claim 1 further comprising a capping structure protruding upwardly from the flange portion proximal to the throat and extending thereover in a sealing manner.

12. The leak control flange of claim 11, wherein the capping structure comprises an upwardly extending water level gauge.

13. The leak control flange of claim 12., wherein the water level gauge is an upwardly extending protrusion with a series of equally spaced markings along its length.

14. The leak control flange of claim 12, wherein the water level gauge is at least partially formed by concentrically stacked cylinders of equal height and decreasing diameter.

15. The leak control flange of claim 11 further comprising a guide lip extending peripherally around a base of the capping structure.

16. A leak control flange, comprising:
a hollow, cylindrical riser portion forming a throat therethrough;
a horizontal flange portion extending outwardly from an upper end of the riser portion;
horizontal channels that each extend, from a channel inlet on a periphery of the flange portion, along an underside of the flange portion, and inwardly towards the riser portion; and
vertical channels that each extend substantially vertically along an outer surface of the riser portion to a channel outlet at a lower end thereof;
wherein at least a first portion of the horizontal channels meet and open into an upper end of one of the vertical channels.

17. The leak control flange of claim 16 further comprising a plurality of one-way valves arranged to inhibit liquid backflow in through the channel outlets and/or out through the channel inlets.

18. The leak control flange of claim 16, wherein the horizontal channels extend through a wall of the riser portion and open into the throat; and
the leak control flange further comprises a plurality of one-way valves arranged to inhibit liquid backflow entering the horizontal channels from within the throat.

19. The leak control flange of claim 16, wherein, the vertical channels are adapted to provide compression gaps for the riser portion to promote compression fitting.
